(19) United States
(12) Patent Application Publication
(10) Pub. No.: US 2004/0122689 A1
(43) Pub. Date: Jun. 24, 2004

(54) Method and apparatus for tracking a part

(76) Inventors: Roger S. Dailey, Brimfield, IL (US); Alan E. Dorsey, Lacon, IL (US)

Correspondence Address: CATERPILLAR INC., 100 N.E. ADAMS STREET, PATENT DEPT., PEORIA, IL, 616296490

(21) Appl. No.: 10/327,559

(22) Filed: Dec. 20, 2002

(51) Int. Cl. G06F 17/60

(52) U.S. Cl. 705/1; 705/7

(57) ABSTRACT

The present invention includes a method and system configured to track a product having a plurality of parts, where at least one of the parts is a new part. The method may include the steps of establishing a design associated with the new part, establishing at least one logistics characteristics of the product parts, and tracking at least one of the logistics characteristics of the plurality of product parts.

### TECHNICAL FIELD

This invention relates generally to a method and apparatus of tracking a part, and more particularly, to an apparatus and method configured track a new product having at least one new part.

### BACKGROUND

Tracking a product, such as a new product, or a product being modified, through the development process, e.g., design and procurement process is difficult. Especially when large numbers of parts may be included in the product. Without a tracking tool there may be many problems that occur leading to cost overruns, missed delivery dates etc. Some tools exist that may assist in a particular phase of development process. For example, some tools assist in creating a part design. Some tools assist in comparing one specified part design with another specified part design. However, without an overall tracking tool to track the part during the development process, the resulting product may be overpriced, behind schedule, and improperly designed.

### SUMMARY OF THE INVENTION

In one aspect of the present invention, a method of tracking a product having a plurality of parts, at least one of the parts being a new part, is disclosed. The method includes the steps of establishing a design of the new part, establishing at least one logistics characteristic of the product parts, and tracking the logistics characteristic of the product parts.

In another aspect of the present invention, a system configured to track a plurality of parts, at least one of the parts being a new part is disclosed. The system comprises a repository configured to store a plurality of part designs, and a controller configured to establish a design of a new part, establish at least one logistics characteristic of the product parts, and track the logistics characteristic.

### BRIEF DESCRIPTION OF THE DRAWINGS

FIG. 1 illustrates one embodiment of a computer system associated with the present invention; and

FIG. 2 illustrates one embodiment of method configured to track a product.

### DETAILED DESCRIPTION

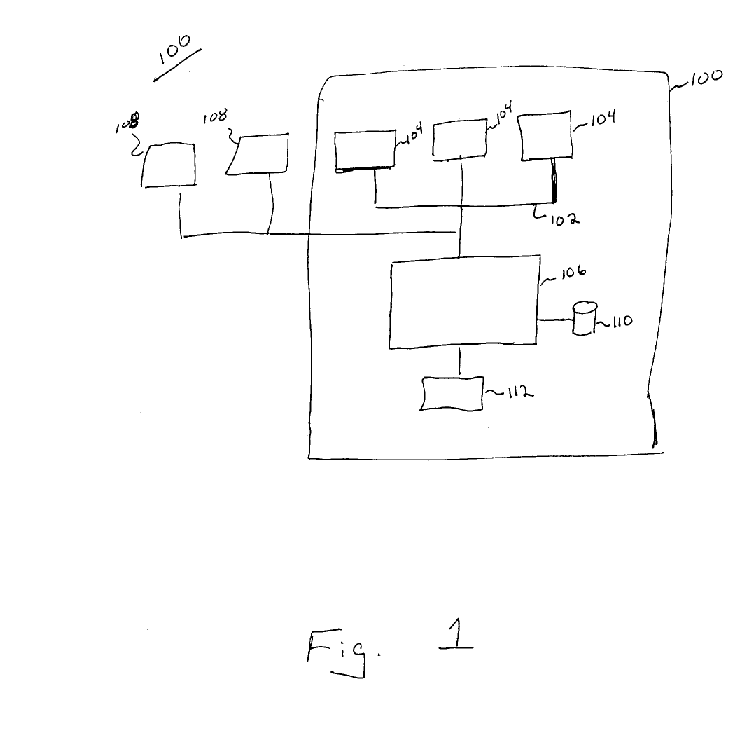

The present invention provides a method and apparatus of tracking a new product having at least one new part. A new product may be a completely new product, or a previous product design that is being modified or redesigned. In one embodiment, the product is tracked from the initial design phase through the initial development phase of the new product. Alternatively, the tracking period may include the initial design phase through the production phase. For example, the tracking period may include one or more of the design phase, development phase, initial testing phase, pilot production phase, and/or production phase. FIG. 1 is an illustration of one embodiment of a computer system 100 that may be used to facilitate new product tracking. The computer system 100 may include a central computer (or computer system) 106. The central computer may be attached to a computer network 102 which is electronically attached to one or more computers 104, or computer systems, which will enable multiple users either internal or external to the computer system 100, to be able to electronically communicate with the computer system 100. The computer system 100 may be a single computer (or computer system) 106, or a network of computers connected together in a manner to enable easy access to any other computer in the computer system 100. For example the computer system 100 may include a distributed architecture, as illustrated in FIG. 1, or a centralized architecture, such as a standalone computer 106. In one embodiment, the computer system may include a repository 110 configured to store one or more part designs. In addition, the computer system 100 may include a user interface 112 configured to interact with one or more users to track the parts. In one embodiment, the user interface may be a web enabled interface.

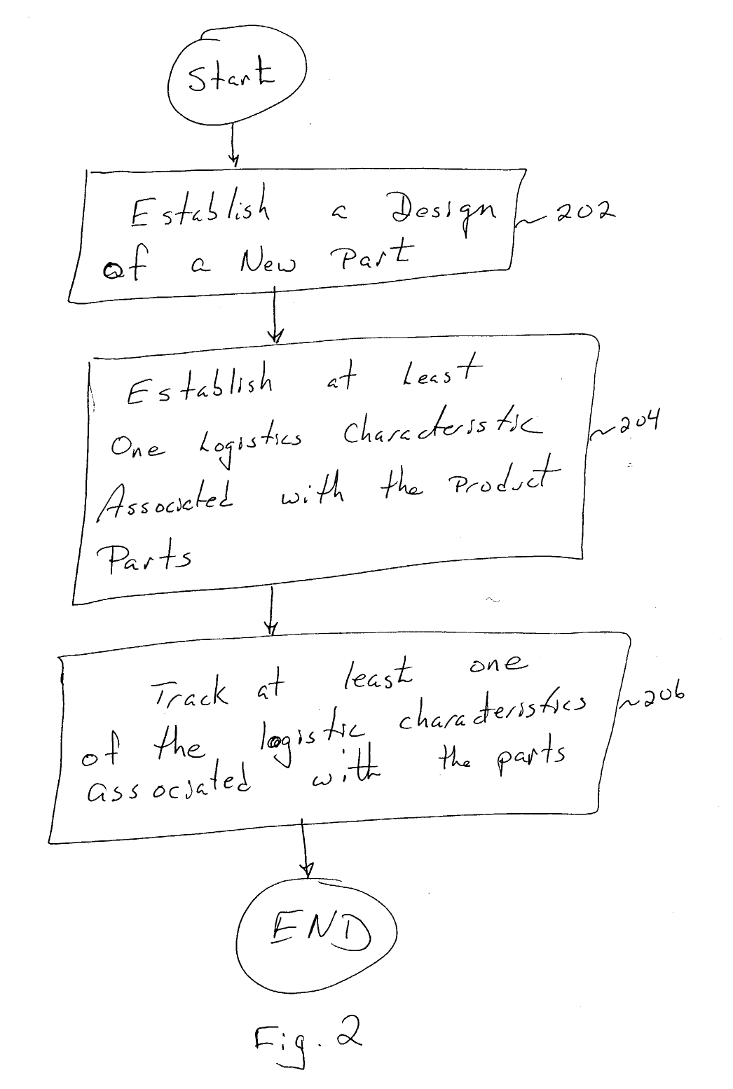

FIG. 2 illustrates one embodiment of the method of the present invention. The present invention includes a method of tracking a new product having at least one new part or product. The method includes the steps of establishing a design of the new part, establishing at least one logistics characteristic of a plurality of new product parts, and tracking said at least one logistics characteristic of said plurality of product parts. In a first control block 202, the design of a new part may be established. The establishment of a new part design may include designing a new part to be included in the product or accessing a new part that has already been designed. A new part may be designed using a variety of electronic design tools. In one embodiment, the computer system 100 may include the design tools. Therefore, a user, such as a design engineer may access the design tool via the computer system 100 and design the new part that is to be integrated into the product. The product may comprised of all new parts, all old part designs, or a combination thereof. For example, the design tool may be located on computer 106 or 104. Potential design tools may include tools such as Pro-Engineering. The design tool may generate an electronic file that includes a drawing of the part in multiple dimensions. The electronic file may include other information associated with the part such as part dimensions, material type of the part, weight, list and/or illustration of other parts the designed part will integrate with, target cost, potential suppliers, reasons for the part, special design or functional features associated with the part, the designer of the part, part number, the date the design was entered into the system, the application or product the part will be used in, a part name, etc. In an alternative embodiment, the part may be designed on a computer 108 external to the computer system 100, and then the electronic design file may be transferred to the system 100 across the network 102. For example, the part may be designed on a computer or computer system 104 used for designing parts, and then transferred to the computer system 100 via the network 102. In one embodiment, once established, the electronic part design file may be stored in a repository, or database, of electronic part design files. The parts design repository may include both existing parts that will be used within the product, new part designs that will be used in the product, and designs of parts no longer in use. In this manner, a parts repository is established. In one embodiment, the repository may include links to one or more external repositories. For example, different departments within an organization may have different part design repositories. Therefore, in one embodiment, the repository may be able to access these repositories when appropriate. Alternatively, the repository may include a list, or complete copy of the part designs in the local repository.

In one embodiment, once a new part design is established, the new design may be compared with other part designs, existing and new, within the part repository. In one embodiment this part comparison may be performed by a tool, such as Pro-Engineer or Solid View, which compare a part design with other identified part designs. The comparison may be manually requested by a user of the tracking system, or the comparison may occur automatically upon the establishment of a new part. The comparison may occur when a new part design is established, or when a part design is submitted, new or existing, into the parts repository. For example, once a new design is initially stored electronically in the parts repository, the comparison tool may be automatically activated and perform a comparison of the new design with the other part designs in the repository. The comparison may include the comparison of one or more part characteristics, such as design characteristics of the part, part weight, cost, and/or reliability and/or design criteria of the part. The result of the comparison may be the identification of one or more parts in the repository that are similar to the part design being stored. The similar parts may be identified, enabling a user to access the similar parts and perform a visual and/or manual comparison of the part designs and any associated information. Alternatively, the tracking system may display the similar part and the new part, and highlight the differences between the stored part and the new part. In one embodiment, the system may recommend a replacement of the new part design, with the existing part design based on the comparison. The user will then have the opportunity to determine if they would like to modify either the stored part, or the part being stored (i.e., new part) in order to be able to use one part design in multiple places. For example, with a few changes the stored part and part to be stored may become interchangeable, thereby potentially reducing manufacturing cost or procurement cost of the product as a whole. The comparison may occur each time a part is initially stored in the repository, once all the parts desired to be used in the product are stored, or at one or more intermediate steps. The comparison may occur before a design review (e.g., part design review as will be discussed), after a design review, or both.

In one embodiment, a new part design may be compared with other existing or proposed designs, by searching a repository for analogous parts. That is, in one embodiment, all part designs may be compared with the new part. Alternatively, the repository may store part designs into categories, some of which may have sub-categories. The design comparison may be performed by establishing one or more categories applicable to the new part design, and then searching those categories for analogous part designs. Categories may be based on the name of the part (e.g., damper, retainer, controller etc.), application or product the part will be used in, weight, cost, material, and/or facility or location using the part. For example, in one embodiment, the search may begin by identifying the facility that will use the part. Identifying the using facility is one way to identify the application the part will be utilized (e.g., an engine part, a transmission part, user interface part etc.). A list of part names may be searched to determine if any other part names include, or are analogous to the new part name. The resulting potential part list may be further searched based on characteristics such as weight, dimensions, cost etc. In one embodiment, a list of part characteristics associated with the parts may be searched to see if there are any parts having analogous characteristics (e.g. function, type, weight, material etc.). Once one or more parts have been identified for comparison, the user may access the comparable parts and determine if they are interchangeable etc.

In one embodiment, once potentially comparable parts are identified, additional information regarding the comparable parts may be used to analyze the design, or be used during the comparison. For example, warranty information may be stored and correlated with one or more of the existing parts. If the warranty information is available, then the information may be used to determine if an existing part has an undesirably high warranty problem. If there is an undesirably high warranty problem, then the existing part may be ignored, or an alternative supplier may be used for the new part, or the reasons for the warranty problems may be analyzed and used to improve the design of the new part. The same process may be used for reliability that may be associated with the potentially comparable parts. In addition, part cost may be reviewed. For example, the cost of new part may be predicted based on the other parts in the repository. For example, a relationship may be developed using some form of statistical analysis based on the parts in the repository. The relationship may be used to predict the cost of the part based on similar parts. In addition, analysis may be performed to determine the cost effectiveness of a particular supplier relative to this part, relative to a particular part material, relative to other suppliers etc. Therefore the relationship may be analyzed to predict the cost of the part, and guide decisions regarding the material of the part, the reliability of the part, a desired supplier for the part etc. As mentioned, the warranty and/or reliability information, and associated pricing information may be used to identify a preferred supplier for the new part.

In one embodiment, once a new part design has been established a design review may be requested. In one embodiment, the design request may be automatically generated. For example, once the new part design is stored into the repository, an automatic request for design review may be sent to one or more users associated with the design of the product and potential manufactures or suppliers of the design. The product design users may review the part to determine how well it may be integrated with the product. For example, the new design may be reviewed to ensure it will be compatible with other parts it may interface with, e.g., physically connect to, electronically connect to, or influence the operation of. The location of the part relative to the product may be reviewed. In addition, the new design may be reviewed to determine the reliability (if this hasn't been determined yet) of the part, reliability of the product based on the parts reliability, or projected weight of the part (if this hasn't been determined yet), and/or the impact of the weight of the new part on the product. In addition, manufacturers and/or suppliers may review the part to identify what will be involved in manufacturing the part, and provide a review of the part which may include, anticipated cost of manufacturing the part, modifications to the part which may help reduce the projected manufacturing cost, weight or reliability of the part. The automatic design review request may be generated by establishing a list of reviewers. As mentioned, the list may include internal and external reviewers. The reviewers may include potential suppliers, product designers, part engineers, reliability personnel, warranty personnel, etc. The list of reviewers may include reviewers that review multiple parts, or reviewers that are only reviewing this particular part design. The reviewers may be notified of the review request in several different ways. For example, in one embodiment, the reviewer may receive an electronic communication in response to the establishment of the new part design. The electronic communication may be an e-mail requesting the review. The e-mail may include the electronic design of the part to be reviewed. In one embodiment, the e-mail may be automatically generated. For example, an e-mail may be automatically generated upon the completion of a design to be reviewed. In one embodiment, the e-mail may be generated in response to a user who indicates the design is complete, and to notify the reviewers. The system may then access the list of reviewers, the part design (or portions thereof), and begin sending e-mails to the reviewers. Therefore, the reviewer may access the electronic part itself. Alternatively, the reviewer may receive the request, and then access the electronic part design through a website that the review requestor has provided them access to. For example, the e-mail may include a link that may be activated to connect to the appropriate website. Once on the website, the reviewer may access the appropriate part for review. For example, the website may have a button or icon that may be activated in order to display a list of one or more parts to be reviewed. The parts list may be a general list of the parts of the product to be reviewed, parts of this and other products to be reviewed, or simply a list of one or more parts to be reviewed by this particular reviewer. The reviewer may then access the appropriate part design and begin the review.

Alternatively, the method of requesting the review may include automatically generating a fax that will include a print out of the part design and associated information to be sent to the reviewer. Alternatively, a mail package may be automatically generated which will include the part design and associated information and to be sent to the reviewer.

Once a design review request has been made, then one or more design reviews may be received. The reviews may include changes to the part design, written analysis of the part design, recommendations for change of the part design to reduce manufacturing cost, increase reliability, reduce weight, improve the maintenance or access of the part, improve the interface of the part with the product, projected cost of the part, suggested material for making the part, reliability and weight information pertaining to the part, information indicating how well the part will interface with the product, or other products to be interfaced with, and/or the lead time needed to manufacture or deliver the part. The review may be received by fax or mail. Alternatively an electronic review may be received. For example, an e-mail may be received which includes a modified part design, and/or descriptive review of the part. In on embodiment, if the reviewer has access to the website the part is located on, the review may be entered directly into the website, at a designated location. The web site may include a button or icon, which when activated will present one or more parts that were to be reviewed by the reviewer. The reviewer may activate a button, icon, associated with the part to be reviewed, or select the part from the list, e.g., via a pull down menu, and then be presented with the option of either accessing the part for review, or providing input based on the review of the part. In one embodiment, the electronic file of the part may be accessed, modified, and/or stored as a modified part, based on the review of the part.

Once one or more reviews have been received, the design of the part may be re-evaluated in light of the reviews to determine if the design of the part is to be modified. In one embodiment, once the changes to the design have been made, if any, the part may be compared to the other parts in the product to determine if there are any similar parts. This comparison may occur for the first time during this step of the process, or may be in addition to having performed a comparison earlier in the process, e.g., once an initial part design has been established. The review process may be an iterative.

Once a final part design is established, a request procurement of one or more parts of the product may be generated. A request for procurement may include a request for bids to supply the part (e.g., a bid request). In one embodiment, the procurement request may be automatically generated upon the establishment of the final part design. For example, if there is a final design repository, once the part design is placed in the repository, an automatic request for bids may be generated. In one embodiment, the system 100 may include an option for the user to select (e.g., “Request for Bids”), that, when selected, would access a list of potential bidders, and the part design (or a portion thereof) and/or associated part characteristics, and then begin generating the request for bids to have the part manufactured, assembled, developed etc. The list of potential bidders, or suppliers, may include suppliers who have reviewed the part, suppliers of similar parts, all part suppliers etc. In one embodiment, the list of suppliers may be generated based on the established part relationship. For example the relationship may be utilized to determine which supplier, or group of suppliers make similar parts, and which suppliers are more cost effective than others, etc. The list of potential suppliers may be manually generated or automatically generated. Alternatively the request may be manually generated. For example, upon the establishment of the final part design, a user may activate a procurement request button or icon that will then automatically generate the procurement request. The procurement request may be performed by delivering an electronic communication to one or more potential suppliers of the part. The electronic communication may include other information for the request for procurement, such as desired delivery schedule, requested due date, quantities etc. In addition the request may include an electronic copy of the part design, including projected weight, cost, reasons for the part, description of functions of features of the parts, and a design engineers name who may be contacted to discuss the part, whether the part is of rough or finished stock etc. The electronic communication may be in the form of an e-mail, which includes the associated information and electronic part design. Alternatively, the e-mail may include the location of a website the potential supplier may access to review the information associated with the bid. The e-mail may include a link which, when activated will connect the potential supplier to the website. The website may include a button or icon labeled procurement request, for example, which once activated will display a list of one or more parts that have associated procurement request. The potential supplier may have access to all procurement request, or only the procurement request that they have been asked to participate in. Once a particular procurement request for a part is selected, e.g., via a pull down menu, or typed in at a data prompt, then the information associated with the part design may be displayed to the user, including the electronic file of the part design. In addition, the potential supplier may activate a button or icon to display a data field for information associated with the procurement response, or bid, to be entered. The procurement request may be delivered to one or more potential suppliers. For example, upon the establishment of the final part design, the user may activate a button, icon, or pull down menu, in order to display a list of the potential suppliers for this part. The user may also be provided the option of adding or deleting potential suppliers from this list. The procurement request will be delivered to the potential suppliers located on the potential supplier list. In one embodiment, the procurement request may occur by generating a fax that includes the procurement request and associated part information, such as the part specification, part drawings, desired delivery schedules etc. Alternatively, the procurement request may occur be generating a procurement request package to be mailed to the potential suppliers.

One or more responses to the procurement request may be received. The response to the procurement request (e.g., a bid from a supplier) may be received via e-mail, fax, regular mail, or by the potential supplier posting, or entering, the request on the website. In one embodiment, if the response is electronically received (e.g., e-mail or some other form of electronic communication) it may be automatically entered into the system 100. Once the procurement responses, or bids, are received, the responses are reviewed, and one or more suppliers may be selected to supply the part.

In a second control block 204, at least one logistics characteristic associated with the product parts is established. The logistics characteristic may include a delivery schedule of the part, including the delivery of the first part, the lead time of the parts, desired inventory of the part, packaging for the part, point of delivery for the part, inventory location for the part, purchase order information etc. In a third control block 206, at least one of the logistics characteristics associated with the product part is tracked. In one embodiment, a project schedule may be established for the product. The project schedule may include the schedules of the parts, i.e., be based upon the logistics characteristics of the parts within the schedule. In one embodiment, the project schedule may be automatically generated in response to accepting one or more of the procurement bids. For example, a software routine may review the projected delivery schedules for each of the parts and establish a project schedule accordingly. Alternatively, a project schedule may be manually established. The project schedule may then be reviewed with regard to the logistics characteristics of the parts. For example, the project schedule may identify desired delivery dates of parts. The desired delivery dates may be compared to projected delivery dates. If there is a discrepancy between the two, example, the projected delivery date is longer than the desired delivery date then the project schedule may be automatically modified accordingly, or a project personnel, e.g., project manager, may be notified of the discrepancy along with the impact of the discrepancy, or the supplier may be automatically notified to determine if the part delivery may be expedited.

In addition, one or more of the individual part schedules may be monitored. The desired part schedule may be compared with an actual part schedule, or a projected part schedule. If a part is late being received, then a part shortage message may be delivered to the project person and/or supplier identifying the part shortage and or impact of the part shortage (e.g., impact on schedule). In addition, a potential part shortage may be generated a designated number of days before the part delivery is due. The potential shortage may serve as a notice to the project person and/or supplier that part delivery is expected so that they may ascertain the status of part delivery and take any action necessary. In addition, a part shipment date may be established for one or more parts. Then, upon the projected part shipment date a notification may be delivered to the project person or the supplier that the part shipment should occur so that notification may occur and corrective action taken if necessary (e.g., if the part was not actually shipped). For example, an automatic projected shipment notification may be delivered to the supplier by the system upon the date of the projected shipment. If a positive shipment response is not received within a specified period of time, e.g., by the end of the day, then the project person may be notified of the part shipment issue so that the project person may investigate the issue and take corrective action if necessary.

In one embodiment, an actual inventory of parts may be established. One or more of the parts may have a desired inventory. The desired inventory may be compared to the actual inventory. If there is a discrepancy between the two, e.g., the actual inventory is less than the desired inventory, the a notification may be delivered to a project person and or the supplier. For example, a notification may go out to the supplier in the form of an automatic request for procurement of the part. Alternatively an inquiry may be delivered to the supplier, if a shipment was expected but not received which led to the shortage. Therefore, the project schedule may be managed by managing and tracking the progress if one or more of the individual parts.

In one embodiment of the present invention, the system 100, which may include tracking tool or function, may analyze one or more of the logistics characteristics and establish a product status report. For example, the project status report may identify which parts have not been ordered, which parts have not been delivered, which parts are needed, which parts are not meeting desired standards, which parts are exceeding desired cost, the impact to a desired milestone (e.g., product production date, product testing date, cost etc.) due to part delays, shortages, or cost overruns.

In one embodiment of the present invention, the tracking tool may be able to analyze the parts repository and establish at least one part procurement characteristic. A part procurement characteristic may include the overall number of suppliers used to procure the parts, the number of suppliers used to procure analogous parts, the cost of part procurement for analogous parts (e.g., further broken down by supplier, type of part, type of material, weight, etc), the warranty claims associated with the suppliers (in general, and in parts groupings if desired) the return rate associated with the suppliers (in general, and in parts groupings if desired), delivery performance for the suppliers etc. The established part procurement characteristic(s) may be used to develop a sourcing strategy. For example, if multiple suppliers are being used to deliver analogous parts, an analysis may be performed to determine if there are advantages (e.g., cost reductions) to be obtained if the number of suppliers may be reduced. In addition, if one supplier has a higher warranty claim amount for the parts they deliver than another, then preference may be given to procuring parts from the supplier with the lower warranty rate. In one embodiment, a prioritized supplier list may be established where supplier is evaluated on an established set of factors (or procurement characteristics). For example, the warranty claims, return rates, delivery performance etc., may be characteristics that may be weighted to reflect importance, and then added together to provide an overall evaluation metric for each supplier. In this way, a prioritized list of suppliers may be established and referenced when attempting to procure a new part, or developing a procurement strategy where supplier comparison is desired, e.g., for reducing the number of suppliers, reducing part procurement cost, reducing part lifetime cost (due to warranty cost or part return cost), or ensuring delivery dates are being achieved.

### INDUSTRIAL APPLICABILITY

The present invention includes a method and system configured to track a product having a plurality of parts, where at least one of the parts is a new part. The method may include the steps of establishing a design associated with the new part, establishing at least one logistics characteristics of the product parts, and tracking at least one of the logistics characteristics of the plurality of product parts. In one embodiment, the tracking may occur through one or more of the design, development, initial testing, pilot production, and/or production phases. For example, a new part design may be proposed during the design phase. The proposed new part design may be compared with existing part designs to determine if any synergies may be obtained by combining one or more designs. The proposed new part design may be delivered to one or more reviewers (e.g., suppliers, reliability experts, warranty experts, maintenance experts etc.), to receive feedback on the part. The feedback may include how much it will cost to manufacture the part, what the cost drivers of the part are from a manufacturing perspective, proposed design changes that would reduce the manufacturing cost, what maintenance issues are related to the part (e.g., how easy will the part be to maintain or replace), how reliable will the part be, what changes could be made to make the part more reliable, what warranty issues may be related to the part etc. Feedback may be received and a new part design finalized. The development phase may include the integration of the part designs and/or simulation of the product or associated parts. The initial testing phase may include testing of the part and/or product. The development and/or testing phase may include requesting bids to have the part supplied, selecting a supplier, and then actually ordering a number of parts for the initial testing. A schedule may be developed for the initial testing, pilot production and/or production phases. The ordering and receipt of parts needed to meet the schedule may be scheduled. The progress of the parts being shipped and/or received may be compared with the schedule to determine if desired progress is being achieved. If there are any delays, individuals may be notified, and the downstream impact of the delays may be determined. In addition, the cost of the parts may be tracked to determine if the actual cost are meeting the predicted, or budgeted cost. If there are any cost variations, then individuals may be notified, and the overall budget impact may be updated.

In one embodiment, the coordination of establishing a design, establishing at least one logistics characteristic, and tracking the established logistics characteristic may be performed by a computer based system, which may include a tracking tool. In one embodiment, the computer based system may include a web based interface for users to access and track the progress of the product. In this manner, multiple users throughout the phases of the process, and with different levels of responsibility may interact with system to track the product.

Other aspects, objects, and advantages of the present invention can be obtained from a study of the drawings, the disclosure, and the claims.

What is claimed is:

1. A method of tracking a product having a plurality of parts, at least one of said parts being a new part, comprising the steps of:
establishing a design of said new part;
establishing at least one logistics characteristic of said product parts; and
tracking said at least one logistics characteristic of said plurality of product parts.

2. A method, as set forth in claim 1, further comprising the step of establishing a repository of parts associated with said product, said repository including said new part.

3. A method, as set forth in claim 1, further comprising the step of automatically comparing the new part with at least one existing part.

4. A method, as set forth in claim 3, wherein the step of said comparison further includes the step of comparing at least one of a part design characteristic, a part cost, and a part weight.

5. A method, as set forth in claim 3, wherein the step of said comparison further includes the step of recommending a replacement of said new part design with said existing part design in response to said comparison.

6. A method, as set forth in claim 5, wherein the step of recommending said replacement further includes the steps of:
establishing at least one part design criteria associated with the new part;
comparing said existing part design with said at least one part design criteria; and
recommending a replacement of said new part design with said existing part design in response to said design criteria comparison.

7. A method, as set forth in claim 3, further comprising the step of replacing said new part with said existing part, in response to said comparison.

8. A method, as set forth in claim 1, further comprising the step of generating a request for procurement for the new part.

9. A method, as set forth in claim 8, further comprising the step of receiving at least one bid for said new part procurement.

10. A method, as set forth in claim 1, further comprising the step of generating an automated design review request of said new part design.

11. A method, as set forth in claim 10, further comprising the step of receiving at least one design review in response to said automated design review request.

12. A method, as set forth in claim 11, further comprising the step of establishing a list of part reviewers associated with said new part.

13. A method, as set forth in claim 12, wherein said list includes at least one external reviewer and one internal reviewer.

14. A method, as set forth in claim 10, wherein the step of generating an automated design review request includes the step of automatically delivering an electronic communication to at least one of an internal reviewer an external reviewer in response to said establishment of said new part design.

15. A method, as set forth in claim 14, where said automated design review request includes a request for review of said design with respect to at least one of a manufacturing of said part, a part cost, a part lead time, a part reliability, an integration of said part in said product, a part weight, and a part location with respect to said product.

16. A method, as set forth in claim 10, wherein said design review request includes said new part design.

17. A method, as set forth in claim 8, wherein said automated design review request includes information associated with a location of said new part design through which said new part design may be electronically accessed.

18. A method, as set forth in claim 11, further comprising the step of establishing a final new part design in response to said new part design and said at least one received design review.

19. A method, as set forth in claim 18, wherein said step of generating said procurement request further includes the step of automatically generating said procurement request in response to said establishment of said final new part design.

20. A method, as set forth in claim 19, wherein the step of automatically generating said procurement request further includes the step of automatically delivering an electronic communication associated with said procurement request to at least one external part supplier.

21. A method, as set forth in claim 19, wherein said procurement request includes said new part design.

22. A method, as set forth in claim 19, wherein said automated procurement request includes information associated with a location of said new part design through which said new part design may be electronically accessed.

23. A method, as set forth in claim 1, wherein the step of establishing at least one logistics characteristic further includes the step of establishing a delivery schedule of said new part.

24. A method, as set forth in claim 23, further comprising the steps of:
establishing an actual inventory of said part;
establishing a desired inventory of said part in response to said delivery schedule; and
comparing said actual inventory and said desired inventory.

25. A method, as set forth in claim 24, further comprising the step of automatically notifying one of an external supplier and an internal employee in response to said actual inventory being less then said desired inventory.

26. A method, as set forth in claim 1, wherein said product has a plurality of existing parts and a plurality of new parts, further comprising the step of establishing a desired delivery schedule of said product in response to a desired delivery schedule of each of said plurality of exiting parts and said plurality of new parts.

27. A method, as set forth in claim 24, further comprising the steps of:
establishing an actual delivery schedule of at least one of said existing parts and said new parts; and
modifying said product schedule in response to said at least one actual delivery schedule.

28. A method, as set forth in claim 1, wherein said step of generating said procurement request further includes the step of automatically generating said procurement request in response to said establishment of said new part design.

29. A method, as set forth in claim 28, wherein the step of automatically generating said procurement request further includes the step of automatically delivering an electronic communication associated with said procurement request to at least one external part supplier.

30. A method, as set forth in claim 29, wherein said procurement request includes said new part design.

31. A method, as set forth in claim 30, wherein said automated procurement request includes information associated with a location of said new part design through which said new part design may be electronically accessed.

32. A system configured to track a plurality of parts, at least one of said parts being a new part, comprising:
a repository configured to store a plurality of part designs;
a controller configured to establish a design of a new part in response to said stored part designs, establish at least one logistics characteristic of said product parts, and track said at least one logistics characteristic.

33. A system as set forth in claim 32, where said repository is further configured in one or more categories, said categories having one more of said part designs.

34. A system, as set forth in claim 33, further comprising a user interface configured to receive a request to search at least one of said categories for an analogous part design.
